(19) United States
(12) Patent Application Publication
(10) Pub. No.: US 2008/0165349 A1
(43) Pub. Date: Jul. 10, 2008

(54) APPARATUS FOR TESTING REFLECTIVITY OF LENS

(75) Inventors: KUAN-TE HUANG, Tu-Cheng (TW); TA-HSAING CHAO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/857,371

(22) Filed: Sep. 18, 2007

(30) Foreign Application Priority Data
Jan. 9, 2007 (CN) 200710200024.1

(51) Int. Cl. G01B 9/00

(52) U.S. Cl. 356/124

(57) ABSTRACT

An apparatus for testing reflectivity of a lens includes an integrating sphere, a light source, a moveable carrier, a detector, and a processor. The integrating sphere has a sampling port for permitting light transfer with a lens to be tested and an exit port configured for transmitting light beams reflected by the lens out from the integrating sphere. The light source generates light beams with a wavelength in a certain range and projects the light beams to the lens. The moveable carrier allows a relative movement between the lens and the integrating sphere. The detector includes a light sensor configured for detecting the light intensity transmitted out from the exit port and transforming it into a reflection comparison signal. The processor is configured for comparing a reference signal of light intensity projected to the lens with the reflection comparison signal to obtain reflectivity of the lens.

### TECHNICAL FIELD

The present invention relates to reflectivity testing apparatuses and, particularly, to an apparatus for testing reflectivity of a lens.

### BACKGROUND

Lenses, utilized in eyeglasses or cameras for example, are quite common optical components. Reflectivity, especially in a specific light wavelength range, is an important index by which to evaluate the optical characteristics of a lens.

Typically, reflectivity of a lens is measured by the following method: a light source and a photo multiplier tube (PMT) are positioned above a lens. Part of the light beams emitted from the light source are reflected by the surface of the lens and absorbed by the photo multiplier tube. Reflectivity of the lens is obtained by comparing light intensity incident on the lens with light intensity reflected by the surface of the lens. However, the detection rate of the photo multiplier tube is relatively slow and, as a result, not generally suitable for testing of lenses in mass production. Therefore, it is desired to develop an apparatus for rapidly testing reflectivity of a lens.

### SUMMARY

In accordance with a present embodiment, an apparatus for testing reflectivity of a lens includes an integrating sphere, a light source, a moveable carrier, a detector, and a processor. The integrating sphere has a sampling port for exposing to light beams a lens to be tested and an exit port for transmitting light beams reflected by the lens out from the integrating sphere. The light source is configured (i.e., structured and arranged) for generating light beams with a wavelength in a certain range and for projecting the light beams to the lens. The moveable carrier (e.g., an X-Y-θ table) is configured for facilitating a relative movement between the lens being tested and the integrating sphere. The detector includes a light sensor configured for detecting the light intensity of the light transmitted from the exit port and for transforming the light intensity into a reflection signal for comparison. The processor is configured for comparing a transmission signal corresponding to a light intensity of light initially projected/transmitted to the lens with the reflection signal to obtain reflectivity (e.g., a value of reflection signal divided by a value of the transmission signal) of the tested lens.

Other advantages and novel features will be drawn from the following detailed description of at least one preferred embodiment, when considered conjunction with the attached drawings.

### BRIEF DESCRIPTION OF THE DRAWING

Many aspects of the present apparatus for testing light reflectance of a lens can be better understood with reference to the following drawing. The components in the drawing are not necessarily drawn to scale, the emphasis instead being placed upon clearly illustrating the principles of the present apparatus for testing reflectivity of a lens. Moreover, in the drawing, like reference numerals designate corresponding parts throughout.

FIG. 1 is a schematic view of an apparatus for testing reflectivity of a lens, according to a first present embodiment.

### DETAILED DESCRIPTION OF THE PREFERRED EMBODIMENT

Embodiments of the present apparatus for testing light reflectance of a lens will now be described in detail below and with reference to the drawing.

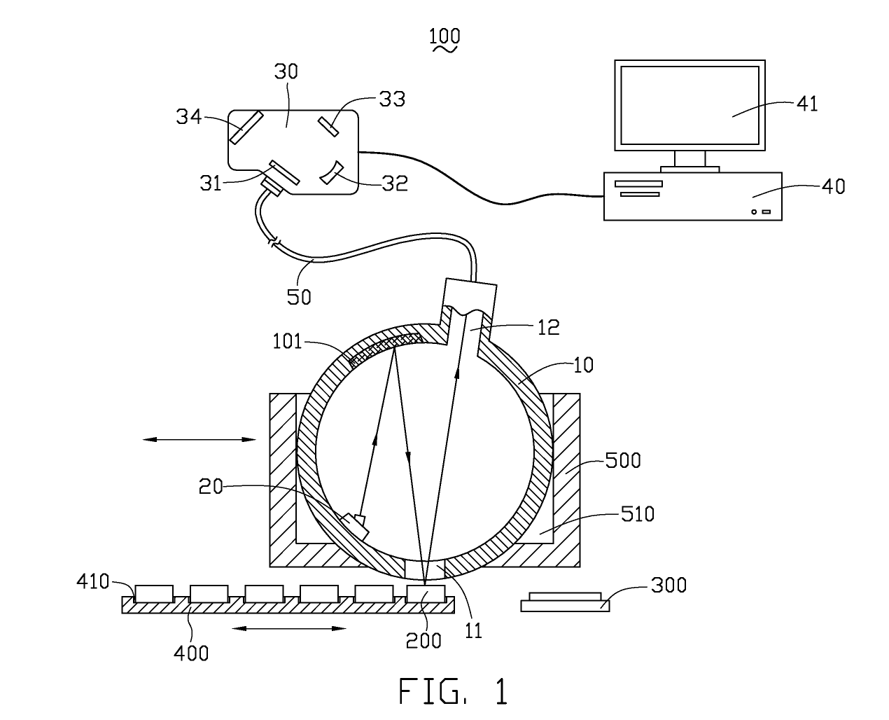

FIG. 1 illustrates an apparatus 100 for testing reflectivity of a lens, in accordance with a first present embodiment. The apparatus 100 includes an integrating sphere 10, a light source 20, a detector 30, a processor 40, a first moveable carrier 400 configured for holding the lens to be tested and for facilitating positioning thereof, and a second moveable carrier 500 configured for positioning/orienting the integrating sphere 10. The light source 20 is disposed inside the integrating sphere 10. The detector 30 connects to the integrating sphere 10 by a light conductor 50, for example, an optical fiber. The detector 30 is electronically coupled to the processor 40.

The integrating sphere 10 is a hollow sphere with a diameter approximately between 50˜60 millimeters. The interior surface of the integrating sphere 10 is coated with a reflective layer 101. The integrating sphere 10 has a sampling port 11 and an exit port 12. The sampling port 11, with a diameter in an approximate range from 10˜12 millimeters, is configured for alignment over a testing lens 200, positioned beneath the sampling port 11, and for thereby permitting light transfer (e.g., transmission and reflection) between the integrating sphere 10 and the testing lens 200. The exit port 12, with a diameter in an approximate range from 10˜12 millimeters, is connected to the light conductor 50 configured for facilitating the transmitting of light beams reflected from the testing lens 200 out from the integrating sphere 10.

The light source 20 can be, e.g., a halogen, incandescent, laser, or a LED lamp with a luminescence equivalent to that produced by an incandescent lamp with a power of about 150 watts. Usefully, the light source 20 is capable of emitting light with a wavelength in a specific range, for example, in the approximate range from 200 to 1100 nanometers. During the measurement, light beams emitted from the light source 20 are transmitted to the testing lens 200 after reflection in the interior of the integrating sphere 10 or are transmitted directly to the testing lens 200. Advantageously, the incident angle of the emitted light beams from the light source 20 projected to the testing lens 200 is controlled to within about 8 degrees of vertical (i.e., to impinge nearly, if not exactly, orthogonally upon the surface of the testing lens 200).

The apparatus 100 opportunely further includes a total reflection (i.e., essentially 100% reflective) standard lens 300. The standard lens 300 is configured for totally reflecting light beams emitted from the light source 20 to the detector 30 to get a reference transmission signal of light intensity, to which the light intensity of the light reflected by the testing lens 200 can be compared. Essentially, the standard lens 300 acts as a calibration/reference lens for calibrating the apparatus 100, in general, and the integrating sphere 10, in particular. Presuming essentially no intensity loss due to the effects of the integrating sphere 10, the detector 30, the light conductor 50, and/or the standard lens 300, the reference signal is essentially equal to the transmission light intensity. Given that the effect of the testing lens 200 on reflectance (e.g., due to light intensity attenuation) is likely much greater than the other elements combined (e.g., for one, only the lens 200, 300 is subject to change in the testing process), such assumptions are likely reasonable.

The detector 30 includes a filter 31, a condenser lens 32, a reflector 33, and a light sensor 34. The light sensor 34 can be selected, beneficially, from a charge couple device (CCD) and a complementary metal oxide semiconductor transistor (CMOS) with, quite suitably, a 3648-pixel resolution to garner a high degree of precision with respect to the present reflectivity measurement. The light beams are transmitted out from the exit port 12 of the integrating sphere 10 to the detector 30 by the light conductor 50. Upon reaching the detector 30, the light beams are split into several light beams of different colors by the filter 31. The split light beams are, in sequence, condensed by the condenser lens 32 and reflected by the reflector 33 to the light sensor 34 for transforming the reflected light intensity into a reflection signal for comparison.

The processor 40 is configured for comparing the reflection signal with the reference transmission signal (i.e., presumed equal to the initial transmission strength of the light source) to obtain the reflectivity of the testing lens 200. Advantageously, the processor 40 further connects to a display interface 41 or to another output means (e.g., an e-mail system, printer, etc.) for outputting the testing result of the reflectivity of the testing lens 200.

The first moveable carrier 400 provides a plurality of concavities 410 (i.e., receiving members) for respectively loading and receiving a number of test lenses 200. The second moveable carrier 500 has a container 510 for receiving the integrating sphere 10 therein. The first moveable carrier 400 and the second moveable carrier 500 are automatically moved and positioned by a pre-determined control program to facilitate a relative movement between the testing lens 200 and the integrating sphere 10. Advantageously, the second moveable carrier 500 may keep still if the first moveable carrier 400 moves, and vice versa. Further, each of the first moveable carrier 400 and the second moveable carrier 500 incorporate, beneficially, an X-Y-θ table to allow for significant control over positioning/orienting of each. The test lenses 200, by being loaded onto the first moveable carrier 400, may, thus, be measured consecutively by the apparatus 100, allowing for a number of test lenses 200 to be evaluating in a short period of time. It is to be understood that the size, shape, and number of concavities 410 can be chosen to accommodate the configuration of the lenses to be tested and the desired batch size of lenses to be evaluated.

The apparatus 100 uses a light conductor 50 connecting to the detector 30 to eliminate the influence of the environment light to the testing result. The detector 30 can be freely disposed at random locations according to different schemes. In addition, the detector 30 employs CCD or CMOS to shorten the testing time of a lens. Furthermore, the detector 30 incorporating the first moveable carrier 400 and the second moveable carrier 500 allow the apparatus 100 to automatically and rapidly test the lenses 200. The average amount of time used to measure the reflectivity of a lens can be below 0.1 seconds. It is to be further understood that, while a hard-wire link is shown between the detector 30 and the processor 40, the electronic link therebetween could be a wireless one, as well.

It is reasonable that apparatus 100 can has only one moveable carrier to achieve the same purpose. The first moveable carrier 400 can be saved by loading the testing lens 200 to a fixed stage, or, instead, the second moveable carrier 500 can be saved by placing the integrating sphere 10 to a fixed holder. Both ways can achieve the same purpose of facilitating a relative movement between the testing lens 200 and the integrating sphere 10.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. An apparatus for testing reflectivity of a lens comprising:
an integrating sphere comprising a sampling port configured for permitting light transfer with a testing lens and an exit port configured for allowing light beams reflected from the testing lens to be transmitted from the integrating sphere;
a light source configured for emitting light beams, the light beams being transmitted to the testing lens;
a moveable carrier configured for facilitating a relative movement between the testing lens and the integrating sphere;
a detector configured for transforming light intensity of light transmitted from the exit port into a reflection comparison signal; and
a processor configured for comparing a signal of light intensity projected to the lens with the reflection comparison signal to obtain the reflectivity of the testing lens.

2. The apparatus as claimed in claim 1, wherein the apparatus further comprises a standard lens, the standard lens completely reflecting light emitting from the light source to the detector to get a reference transmission signal of light intensity.

3. The apparatus as claimed in claim 2, wherein the processor compares the reflection comparison signal with the reference transmission signal to obtain the reflectivity of the testing lens.

4. The apparatus as claimed in claim 1, wherein the light source is received inside the integrating sphere.

5. The apparatus as claimed in claim 1, wherein the light source emits light beams within a specific wavelength range.

6. The apparatus as claimed in claim 5, wherein the detector comprises a light sensor configured for detecting light intensity of the light beams transmitted from the exit port.

7. The apparatus as claimed in claim 1, wherein the light source is selected from the group consisting of halogen, incandescent, laser, and LED lamps.

8. The apparatus as claimed in claim 1, wherein an incident angle of the light beams transmitted to the testing lens is controlled within about 8 degrees of vertical.

9. The apparatus as claimed in claim 1, further comprising a light conductor configured for connecting the exit port of the integrating sphere to the detector.

10. The apparatus as claimed in claim 1, wherein the moveable carrier is controlled by a pre-determined program to facilitate automatic movement and positioning.

11. The apparatus as claimed in claim 1, wherein the moveable carrier provides a plurality of concavities configured for holding a number of test lenses, and the moveable carrier is configured for selectably moving the test lenses relative to the integrating sphere.

12. The apparatus as claimed in claim 1, wherein the moveable carrier provides a container configured for holding the integrating sphere therein, and the moveable carrier is configured for selectably moving the integrating sphere relative to the testing lens.
